(19) United States
(12) Patent Application Publication
(10) Pub. No.: US 2026/0001474 A1
(43) Pub. Date: Jan. 1, 2026

(54) MAGNETIC CARGO STRAP RETAINMENT DEVICE

(71) Applicant: Doug Gollan, Vienna, OH (US)

(72) Inventor: Doug Gollan, Vienna, OH (US)

(21) Appl. No.: 18/756,280

(22) Filed: Jun. 27, 2024

(51) Int. Cl. B60P 7/08

(52) U.S. Cl. CPC B60P 7/0807

(57) ABSTRACT

An adjustable magnetic device for retaining a tie down strap and hook when securing a load in a vehicle. The magnetic device comprises a fitting slidably positioned on a cargo strap adjacent the hook and a magnet receiving fitting that attaches to a vehicle. A pair of oppositely disposed strap access openings and for frictional retainment therebetween provides secure retainment on the cargo strap with the oppositely disposed position magnet exposed for attachment to the surface of the vehicle. The magnetic strap retainment device selectively holds the cargo strap in position after initial strap hook engagement allowing the opposite end of the strap to be engaged and secured over the load on the vehicle.

### BACKGROUND OF THE INVENTION

### 1. Technical Field

This invention relates to cargo securing apparatus and more specifically to cargo tie down straps with engagement hooks and magnetic holders for the tie down straps and hooks.

### 2. Description of Prior Art

Cargo transported by truck, flat bed trailer and the like is typically secured by the placement of cargo tie down straps to prevent movement during shipping. Such cargo tie down straps are secured to anchor points on the vehicle by the use of hooks on the ends of the cargo straps. It is helpful to hold the first hook engaged on the vehicle in place while securing the remaining hook to secure the load.

A number of prior art devices have been developed to retain the first cargo hook engagement position while the remaining end of the cargo strap is secured to the vehicle, see for example U.S. Pat. Nos. 9,725,028, 11,415,157 and U.S. Publications 2023/0136677 and 2024/0042917.

In U.S. Pat. No. 9,725,028 a magnetic fastener for cargo retention can be seen having a magnet fitted on the open end of an S-shaped retainment hook on a cargo strap.

U.S. Pat. No. 11,415,157 discloses a magnet holding device for cargo tie down strap hooks having a magnet holder on the base of a dual hook secured on the free end of a cargo strap.

U.S. Patent Publication 2023/0136677 claims a magnet wedge clamp for a cargo strap having notched plate with a pair of affixed magnets. The cargo strap is passed through the retaining wedge clamp on the cargo strap positioning it in place by the magnets.

U.S. Patent Publication 2024/0042917 discloses a tie down hook magnet reinforcement device having a holster achieving a magnet with a hook secured thereto. The hook can selectively engage a corresponding strap tie down hook holding it in place once secured to the vehicle.

### SUMMARY OF THE INVENTION

A magnetic tie down strap retainment and stabilization device that holds a cargo strap hook in place during tie down. The magnetic tie down hook retainment device is slidably disposed on the tie down strap having a strap engagement buckle like housing through which the cargo strap extends with an oppositely disposed retainment registration magnet for positional engagement on the surface of the vehicle.

### DESCRIPTION OF THE DRAWINGS

FIG. 1 is a perspective view of the cargo strap retainment device of the invention.

FIG. 2 is a rear elevational view thereof.

FIG. 3 is an end elevational view on lines 3-3 of FIG. 1.

FIG. 4 is a top plan view thereof.

FIG. 5 is a bottom plan view thereof.

FIG. 6 is a perspective view of the strap retaining device on a cargo strap with portions broken away.

FIG. 7 is an enlarged partial bottom plan view illustrating the position of a magnet in the strap retainment device on a cargo strap with a hook.

FIG. 8 is a perspective view of the cargo strap retainment device in use on a vehicle with portions broken away.

FIG. 9 is a perspective view illustrating a cargo vehicle with the cargo strap retainment device securing the strap and hook in position on a vehicle.

### DETAILED DESCRIPTION OF THE INVENTION

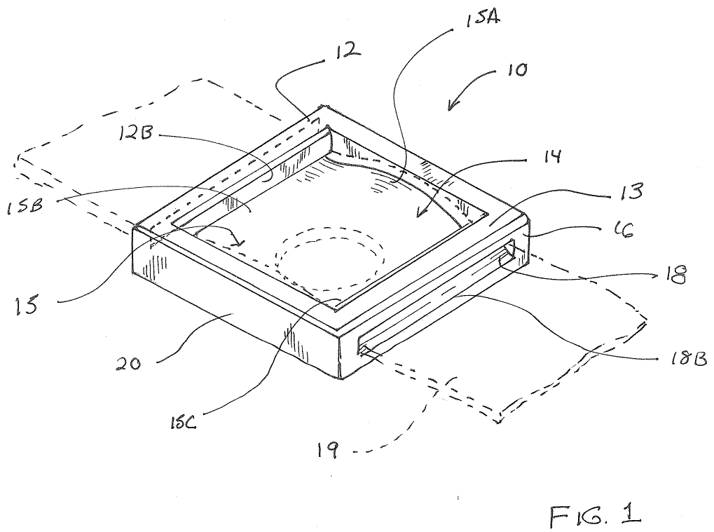

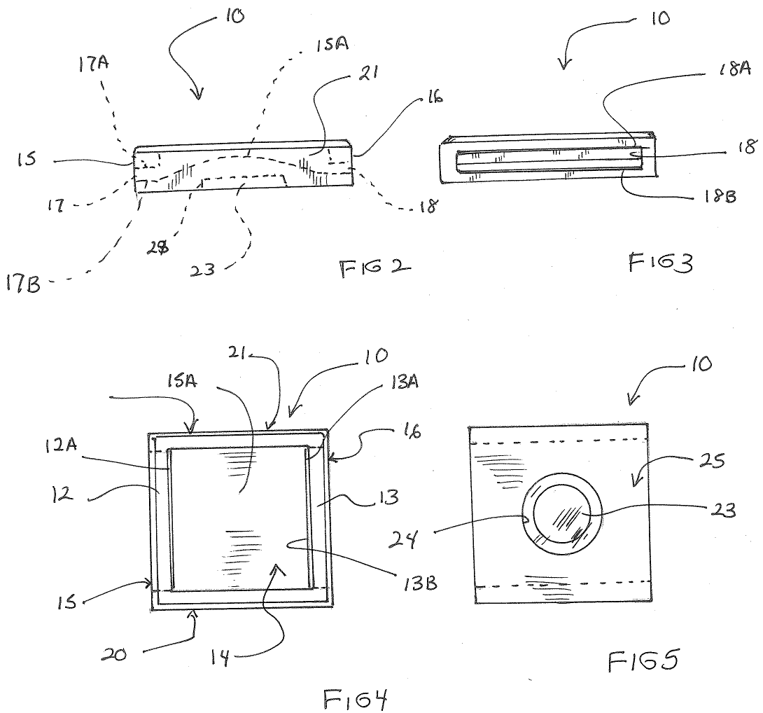

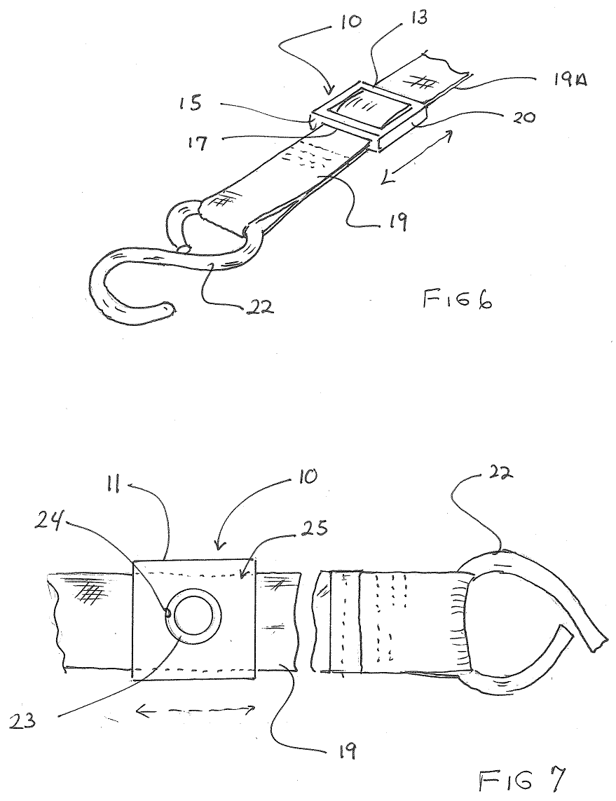

Referring to FIGS. 1-5 of the drawings, a cargo strap retainment device 10 of the invention can be seen having a main body member 11 with a pair of oppositely disposed spaced parallel strap engagement bars 12 and 13 defining strap receiving recess area 14 therewithin. A strap engagement surface 15 extends between the engagement bars 12 and 13 with a center raised portion 15A having tapered depending surfaces 15B and 15C extending respectively therefrom.

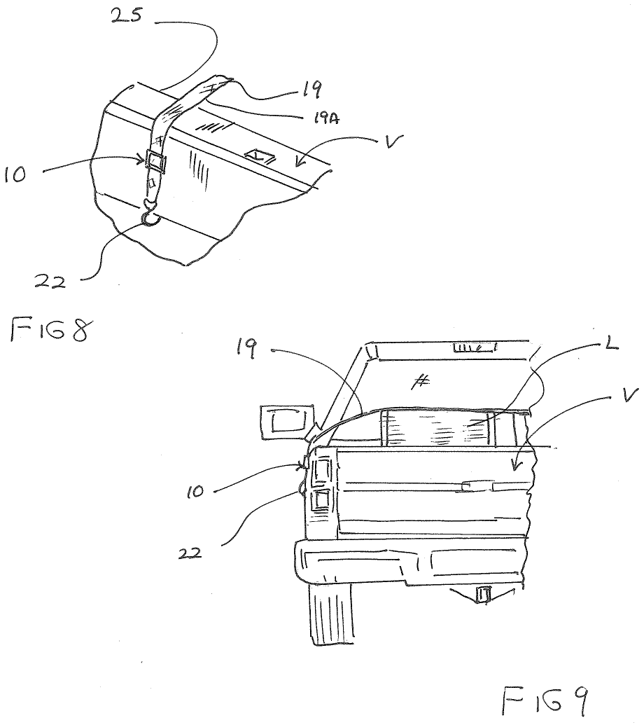

The engagement bars 12 and 13 have respective depending vertical outer end surfaces 15 and 16 with respective rectangular openings 17 and 18 therein for pass through access of a cargo retainment strap 19 shown in broken lines in FIG. 1 of the drawings and in solid lines in FIGS. 6, 7, 8 and 9 of the drawings as will be described in detail hereinafter.

The rectangular openings 17 and 18 each have transversely extending spaced vertical inner tapered surfaces 17A and 17B and 18A and 18B defining strap entrance guide.

The device's body member 11 has spaced parallel front and rear surfaces 20 and 21 extending between the corresponding end engagement bars 12 and 15 and end surfaces 15 and 16 thereby defining the perimeter of the strap retainment body member 11. Depending spaced parallel inner connecting side surfaces 23A and 23B provide transverse stabilization of the retainment strap 19 as it extends through the recessed area 14.

Respective inner longitudinally depending edges 12A and 13A on the engagement bars 12 and 13 are initially tapered transitioning into effacing vertical inner surfaces 12B and 13B in spaced relation to said recess area 14 thereby defining respective inner access openings between the hereinbefore described strap receiving openings 17 and 18.

The retainment cargo strap retainment device 10 can therefore be selectively and slidably secured to the cargo retainment strap 19 as best seen in FIGS. 6-9 of the drawings. Cargo retainment strap 19 has vehicle engagement hooks 22 on its respective ends so as to secure a load L in the vehicle V as is well known and understood by those skilled in the art.

Referring now to FIGS. 1, 5 and 7 of the drawings, a retainment magnet 24 is secured in a recess 25 formed in the center bottom surface 26 of the retainment device body member 11 in oppositely disposed relation to the hereinbefore described strap engagement retainment base 14.

The magnet 24 will thereby magnetically attach the cargo strap retainment device 10 to the surface of the vehicle V, hold the cargo strap 19 and its end engaged hook 22 in position while the other end of the cargo strap 19 is secured. It is important to note that it is notably difficult to maintain the first engaged strap hook 22 while transferring to the other side of the vehicle V cargo bed 25 to secure the free end of the cargo strap 19 thus securing the load L.

It will be evident from the above description that the cargo strap retainment device 10 can be slidably positioned along the cargo strap body 19A as needed so as to hold the engaged cargo strap 19's end hook 22 in position as hereinbefore described.

The cargo strap retainment device 10 is correspondingly held in place on the strap 19 by the frictional engagement of the strap's body 19A between the respective strap receiving bar defining openings 17 and 18 and the convex body base surface 14 as will be understood by those in the art.

It will thus be seen that a new and novel cargo strap retainment device 10 of the invention has been illustrated and described and it will be apparent to those skilled in the art that various changes and modifications may be made thereto without departing from the spirit of the invention.

Therefore, I claim:

1. A device for holding a tie down strap on a vehicle comprises,
a monolithic body member having spaced parallel strap engagement bars having oppositely disposed openings therein of a dimension and order of magnitude of a tie down strap to pass therethrough,
a recess area between said tie down strap engagement bars, spaced parallel depending inner connecting side surfaces between said strap engagement bars and a contoured base in said recessed area for frictional engagement with said tie down strap,
an exposed magnet in said body member in oppositely disposed relation to said contoured base for retainment of said device on a vehicle.

2. The device for holding a tie down strap on a vehicle set forth in claim 1 wherein said contoured base in said recessed area defines, a convex longitudinal surface between said respective openings in said base.

3. The device for holding a tie down strap on a vehicle set forth in claim 1 wherein said magnet is recessed within said body member so as to be flush with surrounding surface for direct mechanical contact on a vehicle surface.

4. A method for holding a tie down strap on a ferromagnetic surface of a vehicle using the device of claim 1, the method comprising passing the tie down strap through said aligned openings in said body member and over the contoured base in said recess area therebetween.

5. The method according to claim 4 further comprises, repositioning the holding device on the strap by loosening the tie down strap therewithin so as to release the device from frictional engagement for longitudinal movement along the tie down strap body and resecuring by tightening the strap therewithin.
